(19) United States
(12) Patent Application Publication
(10) Pub. No.: US 2012/0310730 A1
(43) Pub. Date: Dec. 6, 2012

(54) MEDIA CAMPAIGN RESPONSE METERING SYSTEM

(75) Inventors: Lawrence Janesky, Middlebury, CT (US); Evan Islam, Naugatuck, CT (US)

(73) Assignee: Basement Systems, Inc., Seymour, CT (US)

(21) Appl. No.: 13/118,984

(22) Filed: May 31, 2011

(51) Int. Cl. G06Q 30/00

(52) U.S. Cl. 705/14.45

(57) ABSTRACT

A system comprising the metering of the effectiveness of media campaigns, the system comprising a network and a system backend communicable with said network, the system backend having a processor configured to track at least one media campaign, wherein the at least one media campaign is further associated with at least one manifest indicia embodying a media campaign point of contact and the system backend further configured to communicate via said network with at least one campaign management client managing the at least one media campaign, and define an interface for the at least one campaign management client to associate at least one media affiliate client to the at least one media campaign.

### BACKGROUND

1. Field

The present embodiments relate to the tracking of media campaigns, specifically, regulating the interaction and engagement between the campaign management client and the media affiliate for the media campaign.

2. Brief Description of Related Developments

In the field of marketing, advertisers often spend a great deal of money to ensure that their media campaigns can reach a desired audience or the public at large as well as generate interest from the public based on the media campaign.

Generally, marketing systems may be used where a promoter wants to mount a media campaign. For example, a media campaign may include product or service advertisements, or any other suitable sort of media campaign designed to call attention to itself to promote certain causes. The promoter may seek affiliates in furtherance of the media campaign. Affiliates may be, for example, media sales representatives, for example, radio sales agents, newspaper advertisement sales agents, billboard agents, television advertisement sales agents, websites, or any other suitable media representatives. If engaged, an affiliate may take the promoter's media campaign and present the campaign to the public, for example, with radio ads, billboards, television ads, newspaper ads, websites, or any other suitable means of promoting the media campaign.

The public may view the media campaign through the affiliates. If the public is interested, the public may use contact information from the advertisement of the affiliate with respect to the media campaign. Each contact made by the public utilizing the contact information presented by the media campaign may be indicative of a response by the public. For example, the response may be used as a lead or a hit for a media campaign.

Conventionally, the promoter tends to pay a predetermined amount, and the media affiliate gets benefit of every response, both valid and invalid. The engagement between promoter and media affiliate is generally unrelated to the responses. Thus, promoters are forced to spend additional money for leads that are not interested in the media campaign, netting no benefit to the promoter. This undermines confidence in the effectiveness of the media campaign.

### BRIEF DESCRIPTION OF THE DRAWINGS

The foregoing aspects and other features of the present invention are explained in the following description, taken in connection with the accompanying drawings, wherein:

FIG. 1 is a system diagram of the exemplary embodiments.

FIG. 1A is a block diagram illustrating an exemplary operation of the disclosed embodiments.

FIG. 1B is a schematic diagram of a client user interface in accordance with the exemplary embodiments.

FIG. 1C is embodiment schematic diagram of a user interface in accordance with the exemplary embodiments.

FIG. 2 is a block diagram illustrating characteristics of a response according to an exemplary embodiment.

FIG. 2A is embodiment schematic diagram of a further user interface showing a rules definition format in accordance with the exemplary embodiments.

FIG. 3 is a flow diagram illustrating a method of operation of the media campaign response metering system in accordance with an exemplary embodiment.

### DETAILED DESCRIPTION OF THE EXEMPLARY EMBODIMENTS

The disclosed embodiment is a system for the determination, identification, quantification and qualification of the effectiveness of online and offline media campaigns. The system, in effect, functions as a metering system in interface between a party managing a media campaign and a contracting media affiliate. In one embodiment, the party managing a media campaign (also referred to herein as promoter or campaign manager) may be, for instance, any party that wishes to conduct one or more media campaigns. These could be, but are not limited to, non-profit organizations, commercial entities, religious entities, or any other suitable organizations or individuals that wish to bring a media campaign to the public. In order to increase the return on investment (ROI), promoters may desire to effect media campaigns by means of “per inquiry” marketing (hereinafter “PI”. PI is a form of direct response marketing that asks for the consumer to respond to the media campaign as an indication of interest. As may be realized, the promoter will seek to engage the media affiliates based on the valid responses and the media affiliate desires confirmation of validity to accept such a basis for engagement. The contracting media affiliate may be, for instance, any contracting provider which may be contracted to bring the media campaign to the public. For example, the contracting media affiliate may be newspaper advertisement sales agents, billboard sales agents, web-based advertisement sales agents, radio advertising sales agents, or any other suitable contracting media affiliate. The system may also be capable of correlating online and offline responses to online and offline media campaigns and media campaigns that comprise both online and offline media components. Further, the system may be able to track precisely the responses or inquiries received for any given media campaign, and meter the effectiveness of any media campaign by measuring predetermined characteristics for responses such as the timing, frequency of response, the content of responses, and the quality of the responses. In alternate embodiments, any suitable characteristic characteristics of the responses or respondent may be metered by the system. Further still, the system provide may also provide a meter or metric for engagement between campaigner and contracting media affiliates. In one non-limiting example, the system may act as an interface allowing the campaigner and contracting media affiliates to view and interact with metering data within the system. In alternate embodiments, the system may provide any level of engagement between the campaigner and the contracting media affiliate. The system may also track across multiple media campaigns and track multiple campaign managers and multiple contracting media affiliates.

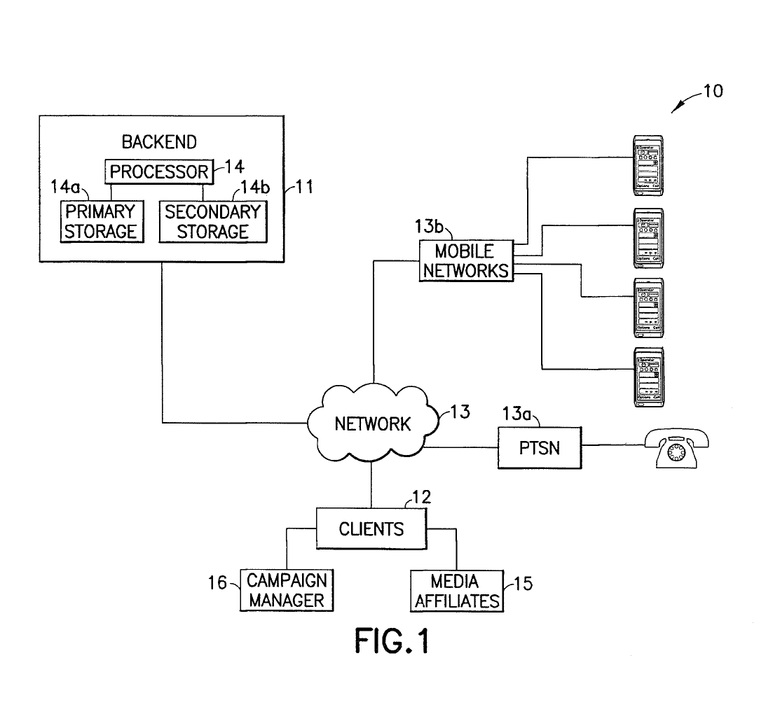

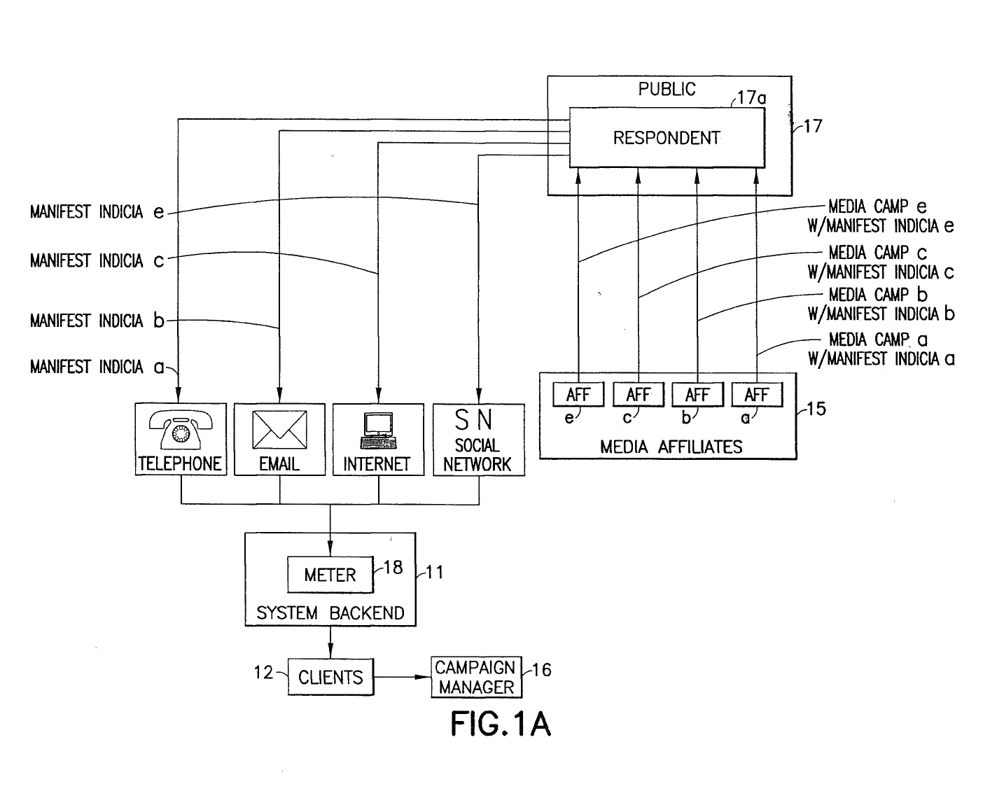

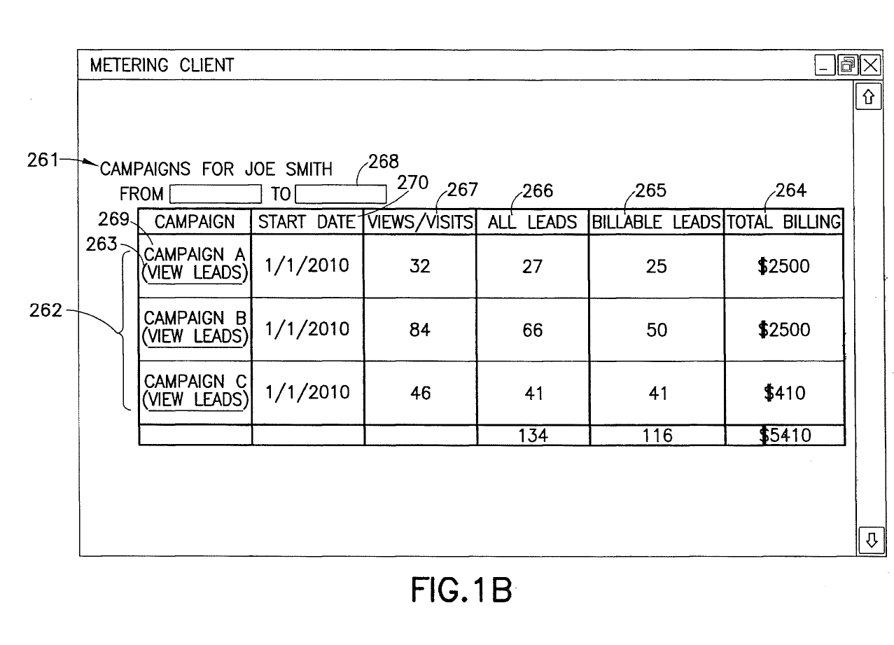

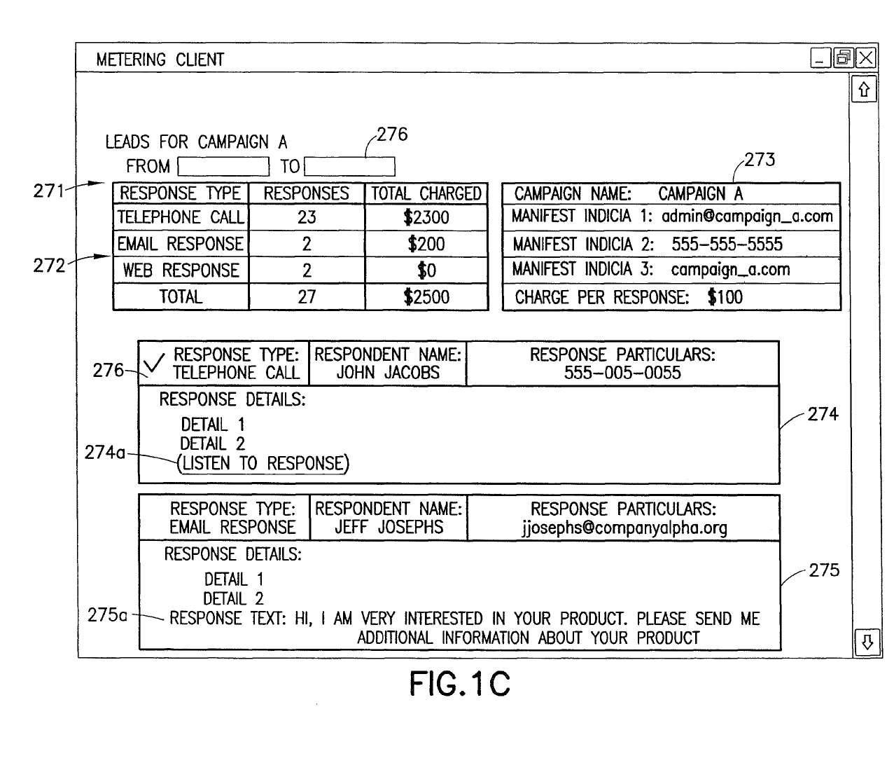

Referring now to FIG. 1, a system diagram of an exemplary embodiment of the system is shown. Although the present invention will be described with reference to the embodiments shown in the drawings, it should be understood that the present exemplary embodiments can be used individually or in any suitable combination thereof. It should also be understood that the foregoing description is only illustrative of the embodiments. Various alternatives and modifications can be devised by those skilled in the art without departing from the embodiments. Accordingly, the present embodiments are intended to embrace all such alternatives, modifications and variances.

Referring again to FIG. 1, a system 10 having a system backend 11 is depicted. The system backend 11 may be in the form of a general purpose computer system or server system. In alternate embodiments, the backend may also be multiple computers or servers or any other suitable device. The system backend 11 may be connected to at least one communications network 13. The network 13 may be, in one exemplary embodiment, the internet, but in alternate embodiments, may be an intranet, extranet or any other suitable communication network. In yet another alternate embodiment, the system backend 11 may connect to a plurality of networks simultaneously. For example, the system backend 11 may also be connected to a Public Switched Telephone Network (PTSN) 13a either through the network 13 (for example, through a VOIP system) or connected directly to the PSTN. In other embodiments, the system backend 11 may be connected to any other suitable networking system or communications system, such as a mobile communications network 13b.

The system backend 11 may have further have a processor 14 as well as primary storage 14a (i.e. RAM or any suitable alternative) as well as secondary storage 14b, such as, but not limited to, a hard drive or multiple hard drives or any other suitable alternatives for persistent storage. In yet alternate embodiments, storage may employ other technologies, such as clouds or other distributed storage systems or any other suitable alternatives. The system backend 11 may be configured to track, quantify and qualify at least one media campaign. A media campaign may be, for instance, a campaign started by a campaign manager to bring awareness to the public of a certain issue by media means. These media campaigns may be, but are not limited to, campaigns for advertising products, public policy issues. In alternate embodiments, these media campaigns may be any suitable kind of campaign. To bring public awareness and to invite inquiries from the public, the campaign manager may contract with a media affiliate. As noted previously, these media affiliates may be newspaper advertisement sales agents, billboard sales agents, web-based advertisement sales agents, radio advertising sales agents, or any other suitable contracting media affiliate. The media affiliates may take the campaign manager's media campaign and present it to the public by their respective media formats. Thus, the media campaign may appear, in non-limiting examples, via newspaper advertisement, billboards, web-based advertising, radio advertisements, social networking advertisements or any other suitable media presentation to the public. Each of these media campaigns and their corresponding relationship with campaign managers and media affiliates may be registered and tracked by a system backend 11 and its processor 14 and may be stored (at least in some representative part) by the system backend within its storage (for example, by means of a relational database, flat tables, or any suitable means of storing the relationship). In one possible embodiment, the media campaign may be assigned a unique identifier by the system backend 11. In alternate embodiments, any suitable means of tracking media campaigns by the system backend 11 may be used. The media campaign may further have at least one manifest indicia associated with it. The manifest indicia may be, for instance, a unique means of contact by which the public can inquire about a media campaign. Each manifest indicia may be used, for instance, to allow a system backend 11 to track what a media campaign respondent (i.e. a member of the public responding to a media campaign) is responding to. For example, this may be in the form of a unique telephone number given to the public within a media campaign, or a unique website URL, or keywords, or web redirects, or parameter data passed between websites, tracking cookies, web analytic information, social networking data (for example, a media campaign respondent may “like” a media campaign on a social networking platform), barcode tags (for example an applicant may scan a barcode or other indicia with a smartphone camera) or any other suitable means to track the responses generated from a media campaign. In alternate embodiments, the manifest indicia may be embodied in any media campaign point of contact usable by a respondent to respond to a media campaign. In another alternate embodiments, the media campaign point of contact accessible by a respondent to a media campaign may, for instance, present additional information to the respondent to indicate that the respondent is at the proper location. This may be, for instance, an audio tone or sound, or a text or graphical overlay, or any other suitable formats that will inform that the respondent is at the proper location. In a non-limiting example, a website-based media point of contact corresponding to a manifest indicia may, for example, have an overlay or popup indicating that this is the proper place for inquiries. In yet other alternate embodiments, a media campaign may also have multiple manifest indicia to track the responses for each media affiliate (or in other words, at least one unique manifest indicia for each distinct media campaign portion, as corresponding to media types used to disseminate the campaign). In such an example, the media campaign may have, by means of non-limiting example, manifest indicia corresponding to two phone numbers (and/or URLs, keywords, email addresses, SMS messaging numbers, or any other suitable manifest indicia)—one used for, by way of example only, a billboard advertisement, another used for, also by way of example only, a radio advertisement. In this example, an inquiry from a respondent to the telephone number corresponding to a billboard advertisement will result in a response counted for a billboard advertisement's response rates, rather than for a radio advertisement.

The system backend 11 may be accessible by at least one client 12 via the network 13. The client may be, for instance, a computer workstation, but in alternate embodiments, may be a smartphone, a PDA, a tablet, or any other suitable devices for accessing a system backend 11 via the network 13. The client may communicate with the system backend 11 by means of a web interface 20, however, in alternate embodiments, the client may also be capable of communicating with the system backend 11 by means of a native client for tracking, or through command line commands, or any other suitable client interface.

Both campaign managers 16 and contracting media affiliates 15 may access the system backend 11 via a client 12. The system backend 11 may be accessible to each campaign manager 16 and contracting media affiliate 15 by means of unique login accounts through the client 12. Each unique login account may be associated with a role. In one instance, a unique login account may have a role of a campaign manager 16, while another may have a role of contracting media affiliate 15. In alternate embodiments, additional user roles may be possible, including, but not limited to, administrator/superuser roles or any other suitable roles. Each account and its corresponding role may allow for different “views” of data stored on the system backend 11 through the client 12. For example, a campaign manager 16 may view, for instance, all media campaigns that they have or had set up through the system backend 11. Further, a campaign manager 16 may further have additional abilities, for example, they may create additional media campaigns and may select a contracting media affiliate 15 for a media campaign. In alternate embodiments, any other suitable abilities may also be possible. A contracting media affiliate 15 may, in contrast, see only the media campaigns they have been contracted for on the system backend via the client 12. A contracting media affiliate 15 may also have any suitable abilities which may be used to control a contracting media affiliate 15 account. Other roles, for example, an administrator/superuser may be able to view all media campaigns via the client 12 and may have additional abilities to administer the system backend. For example, an administrator may have the ability to delete or create new media campaigns, or to delete and add additional accounts or roles or any other suitable abilities. Via the client 12, all campaign managers 16 and contracting media affiliate 15 and any other suitable users, data related to media campaigns may be presented.

Referring now to FIG. 1A, an exemplary diagram of system operations may be seen. The graphic illustration of system operation shown in FIG. 1C is merely exemplary, and in alternate embodiments, the system may have any other suitable structure. A number of campaign managers 16 may access the system backend 11 via a client 12. The client 12, as described above, allows for the advertiser to view and select data as well as managing aspects of a media campaign, such as creating a new media campaign. A number of contracting media affiliates 15 also may access the client 20. Within the context of the system, the campaign manager 16 may, for example, start a new media campaign through the client 12 and then select one or more contracting media affiliates 15 to carry out the media campaign. This may be communicated via the system backend 11 to the contracting media affiliates 15, or may be communicated in any other suitable means, including through external channels. The system 19 may, upon the start of a new media campaign, assign a new campaign identifier and also assign or be assigned one or more manifest indicia for each media campaign. The contracting media affiliates 15, represented by individual media affiliates aff a-e, may present each media campaign to the public 17 presenting information related to the media campaigns a-e, including the information related to a manifest indicia a-e by which the public 17 may respond. As noted previously, the manifest indicia 18 is a means by which communication from a response may be tracked by the system backend 11. A subset of the public 17 will be respondents 17a who receive the information regarding the media campaigns. The respondents 17a will use the manifest indicia 18 to respond to each media campaign. The responses to each manifest indicia are tracked, separately, by the system backend 11 via the manifest indicia 18, which is stored and analyzed with respect to each individual media campaign which may be associated with a unique campaign identifier.

The system backend 11 may also be suitably programed so that the client 12 may also present, in addition to media campaign information, additional types of information. For example, the system backend 11 may allow a client 12 to present to a user additional information related to response data. Response data may be data related to inquiries, hits, or other types of responses for a media campaign. Referring now to FIG. 1B, an exemplary aspect of the data processed and sent by the system backend 11 to the client 12 is shown. The exemplary aspect shown in FIG. 1B presents a view of information related one or more campaigns 262 that are being tracked by the system backend 11 and presented to the client 12. Each media campaign is presented as a row within the user interface 261. In alternate embodiments, any other suitable means of presenting information about media campaigns are also possible. Each media campaign 262 may include a multitude of overview information that is available regarding the media campaigns 262. For example, the campaign name 269 may be presented, along with information related to start dates 270. Further, information on responses may be presented. For example, the viewership or the visits or other suitable activity regarding reach of a media campaign may be shown 267. Other information that may be presented may include information related to leads generated from each media campaign, including all responses 266 for a media campaign and billable responses 265. In on embodiment, a billable response measured in the billable response information 265 may be based upon a predetermined criteria by which a response may be determined to be billable by the system backend 11. Other information presented may include information about invoicing or billing 264. These may be related to the information generated on billable leads 265. The overview user interface 261 may also present additional means of presenting information, for example, by filtering or searching options 268. In the exemplary embodiment shown in FIG. 1B, the filtration method shown by data filter 268 is filtering by date. In alternate embodiments, any suitable filtering or sorting method may be used, including sorting by dates, sorting by names, sorting by criteria, sorting by response information, or any other suitable sorting or filtering method. Further, the overview UI 261 may have links 263 or other similar devices which may allow a user to view a campaign in detail.

Referring now to FIG. 1C, an exemplary aspect of a detailed campaign view (for example, reachable by selecting the link 263 in FIG. 1B) is shown. The campaign detail UI 271 may include multiple aspects. For example, response type overview 272 may include overviews about responses received by system backend 11 with regards to a particular media campaign. Each response type may be related to at least one manifest indicia corresponding to the type of response (for example, telephone responses, email responses, web form responses). In alternate embodiments, any suitable response types may be used and shown in response type overview 272, and may be associated to a corresponding manifest indicia. In manifest indicia overview 273, a listing of the various manifest indicia used by the media campaign and corresponding to a response type seen in response type overview 272 may be shown. Other types of information presented in the overview information shown in 272 and 273 may include, but is not limited to, response rate information, billing information, charge per response information, or any other suitable information. In alternate embodiments, the overview information 272 and 273 may be presented in alternate formats, or omitted completely, depending on the system backend 11 or the client. (For example, a mobile client 12 may require a more simplified user interface than a web-based client.) The campaign detail UI 271 may also include information on responses. The exemplary embodiment shown in FIG. 1C may show the individual responses 274, 275 in a list and corresponding information related to each response such as, for example, response type, respondent name, response particulars, and various response details. The exemplary embodiment shown in FIG. 1C may also allow for the client to optionally listen or read or otherwise view or listen to the responses by the respondent. For example, response 274 may have a link 274 or applet or other suitable means to allow the respondent telephone call to be heard or listen to. This may be suitable, for example, for telephone responses or any other response types involving audio. In response 275, there may be data 275a which shows the response text. This may be suitable, for example, for text-based responses such as web forms or emails, or any other responses related to text communication. In alternate embodiments, any other suitable data may be presented by the system backend 11 to the client 12 related to a detailed campaign information. The system backend 11 may also present certain validity indications 276 related to whether a response is valid or not. This may be according to a measure by the system backend 11 of whether a respondent is interested or not interested in a particular media campaign. The validity indicator 276 may also be presented, in alternate embodiments, in other ways, for example, highlighting or text format differences, or any other suitable means for presenting validity. The campaign detail user interface 271 may also be, in alternate embodiments, capable of filtering response data by a data filter 276. In one embodiment, this may be filtering by date, but in alternate embodiments, any other suitable form of filtering or sorting options may also be used.

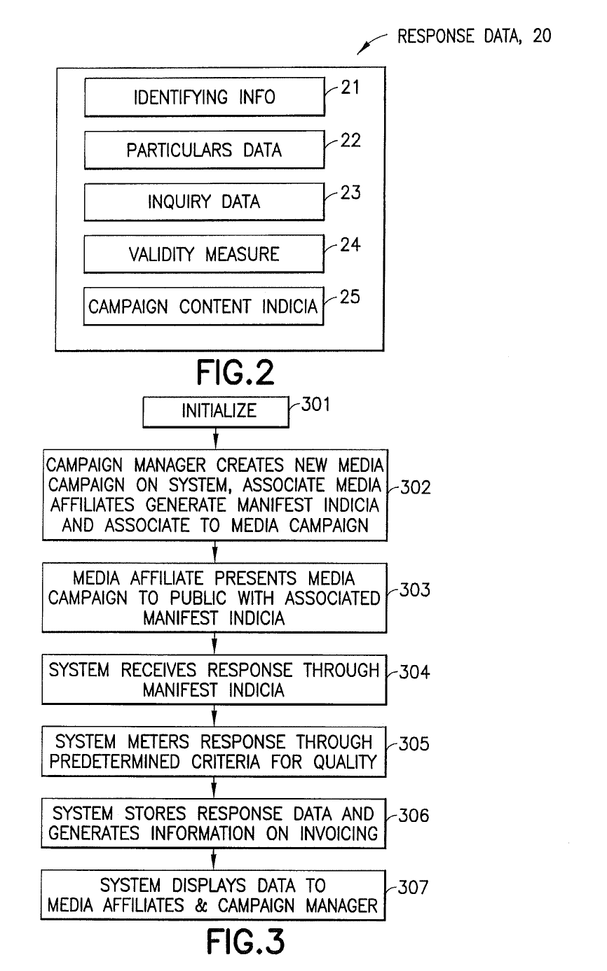

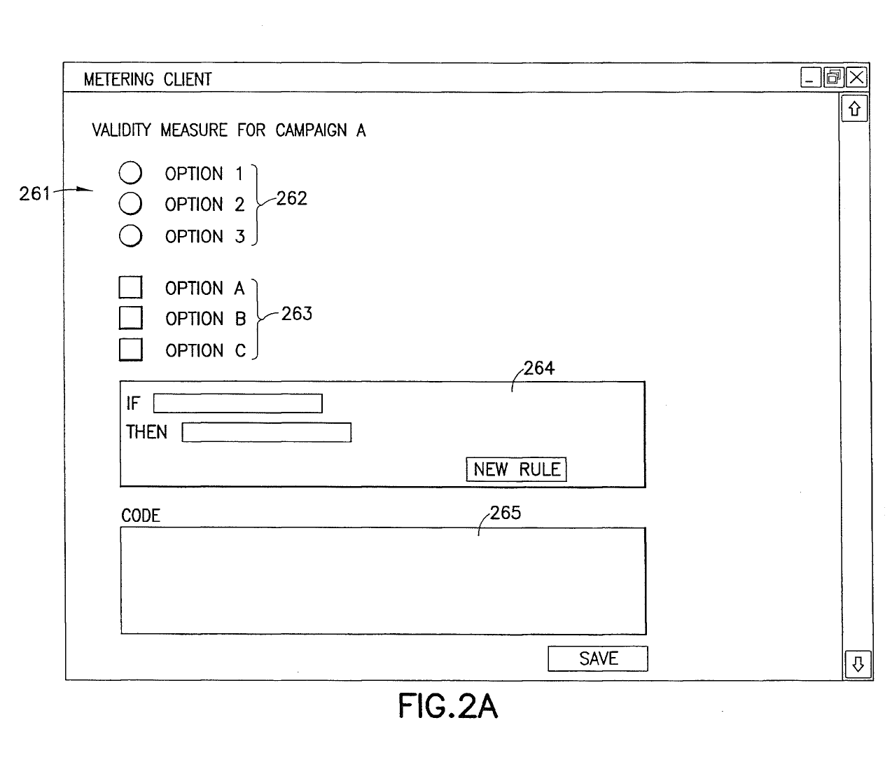

Referring now to FIG. 2, an exemplary block diagram of response data characteristics stored and measured by the system backend 11 is shown. The response data are received by the system backend from respondents 17a by means of the manifest indicia a-e and are captured by the system backend 11. The system backend 11 may store the response characteristics and do additional processing on the response data characteristics before presenting it to a client 12 to be viewed or used by campaign manager 16 or contracting media affiliates 15. Response data characteristics may include, for instance, identifying information 21 or origin of a response. This may be, but is not limited to, a telephone number, email address, or any other contact information for a given response. Additionally, the response may have additional particulars 22. Such particulars 22 may be additional information about a respondent. In one embodiment, the particulars 22 may be the name or organization of a respondent, but in alternate embodiments, any other additional type of information may be included, such as, but not limited to, income levels, interests, or any other particular information. The response data may also include additional data such as inquiry data 23. This may be information regarding individual responses, for instance. In one embodiment, the inquiry data 23 may be, for example, a recording of a telephone inquiry from the respondent. In alternate embodiments, any suitable means of inquiry data 23 may be recorded, such as, but not limited to, the text of an email, or text from a web form response, or link/advertisement click-throughs, or a transcript of a telephone conversation, or faxes, or social media information or any other suitable alternatives.

Response data may also include a validity measure 24. The validity measure 24 may be, for instance, a measure of whether a respondent is interested or not interested in a particular media campaign, and may be defined by information embodied by the response data. The validity measure 24 is measured by the system backend 11 using a meter 18 which meters the validity of the response data information according to a predetermined criteria. For example, the predetermined criteria may be the length of a time for a telephone response—a short telephone call (i.e. less than a predefined threshold) may be automatically considered a invalid response while a longer telephone call may be considered an valid response by the system backend 11. Other examples of predetermined criteria may include analyzing the wording of a message (for example, keywords or some other suitable form of natural language process), frequency of responses, or time or length of contact. In yet alternate embodiments, any form of suitable predetermined criteria may be used to measure validity. In another exemplary embodiment, the response data may have a manual input of validity. For example, an operator receiving a telephone inquiry may be able to indicate via a client 12 whether an inquiry is valid or not by means of manual input. In yet another alternate embodiment, any suitable means of measuring validity may be used. The validity measures 24 may also be configurable or selectable by a campaign manager 16 or contracting media affiliate 15 or any other suitable party. For example, a campaign manager 16 may define predetermined rules and criteria for what is considered a valid response. Such predetermined rules and criteria may be specific keywords, simplified logic rules, or any other suitable criteria such as length of time or any other suitable criteria. Referring now to FIG. 2A, an exemplary rule definition user interface 261 generated by the system backend 11 and presented by the client 12 is shown. The rule generation user interface 261 include various methods of allowing a user to generate predetermined rules and criteria, including radio selectors 262, select boxes 263, simplified logic generator 264, or the direct input of code. The rule definition user interface 261 is merely exemplary and in alternate embodiments, may include other mechanisms for defining rules, including Boolean rule generators, or any other suitable means for generating a set of predetermined rules and criteria. The campaign manager or contracting media affiliate 15 or any other suitable party may be able to change and define predetermined rules and criteria by, in one exemplary embodiment, a simplified user interface. In alternate embodiments, any type of user interface capable of changing and defining predetermined rules and criteria may be used. In yet another embodiment, when predetermined rules and criteria are modified by either a campaign manager 16 or a contracting media affiliate 15, the other party may be asked to confirm and accept the change in predetermined rules and criteria.

Response data may also include campaign content 25. These may be, for instance, all information used within a media campaign. For example response data may include the advertisement graphics, colors, text, audio, video or any other information available for a particular media campaign.

The system backend 11 may be further configured generate data to qualify and quantify the effectiveness of a media campaign by processing the response data. In one exemplary embodiment, the system backend 11 may generate statistical information from the response data. The system 19 may process the response data in aggregate to generate statistics to show the percentage of valid responses from each contracting media affiliate 15 for a media campaign. Further, the statistics generated with any suitable degree of granularity. For example, the system may present statistic information on the overall effectiveness of a media campaign for a media affiliate or for the media campaign in general. However, the system 19 is also flexible enough to allow a party to see, for instance, when a media campaign is the most effective, or locations when a media campaign is effective or any other fine detail. For example, one billboard may be effective near a highway, but another billboard near a rural road may be less effective. If each billboard uses different manifest indicia, the system will be able to pinpoint the locations where campaigns are simply ineffective, allowing campaign managers 16 and contracting media affiliates to weed out ineffective media campaigns. In alternate embodiments, any suitable statistical information may be generated with regards to the response data. The system backend 11 may further generate invoicing or billing data from the response data. In one exemplary embodiment, the system may measure the validity measure based on the response data and generate billing information based on an agreed-to rate. For example, this may be done by generating billing and invoice data by billing the campaign manager 16 for every valid hit. In alternate embodiments, said system backend 11 may generate billing or invoice data with any suitable method, including, but not limited to, tiered billing or any other suitable billing type. Further, the response data stored by the system backend 11 may allow for negotiation between a campaign manager 16 and a contracting media affiliate. For example, the campaign manager 16 and contracting media affiliate may determine the effectiveness of a particular campaign based on the statistical information generated by the system 19 for negotiations for compensation rates (for example, but not limited to, cost per valid response). A low-performing media campaign may have a lower compensation for invoice or billing per valid hit.

Referring now to FIG. 3, an exemplary flow diagram of the operation of the system is shown. In block 301, the system 19 is initialized. At block 302, a campaign manager 16 may begin a media campaign on the system 19 and selects the media affiliates to bring the media campaign to the public. As noted previously, the campaign manager 16 can achieve this by accessing the user interface of a client 12 to start a new media campaign and to select and notify a media affiliate. For example, this may be selecting a party who will bring the media campaign to the public. This may be advertising agents for radio, billboard, TV, newspaper, online advertisement services, or any other suitable parties capable of bringing awareness of a media campaign to the public and to invite inquiries. As noted, the campaign manager 16 may achieve this by selecting at least one contracting media affiliate 15 using the client 12 with the system backend 11. Once a contracting media affiliate 15 has been chosen, the contracting media affiliate 15 may also be able to view details of the media campaign via a client 12. The media campaign may be of any suitable type, for example, product advertisement, issue awareness campaigns, voter registration campaigns, etc. The system 19 will generate unique identifiers for the media campaign that will be tracked by the system 19 to track each media campaign. The system 19 may also assign or be assigned by the campaign manager 16 a number of manifest indicia for the media campaign. As noted previously, manifest indicia are indicia which allow the system to track the responses given for each media campaign. The manifest indicia may be unique email addresses, telephone numbers, or any other suitable manifest indicia as shown above. The campaign manager 16 may also associate one or more contracting media affiliates to the media campaign At block 303, the contracting media affiliate 15 may then present to the public information regarding the media campaign using the manifest indicia assigned. The public may view and respond to the media campaign as presented by the contracting media affiliate by using the manifest indicia assigned at block 302. As each manifest indicia may be unique to each advertising campaign or unique to each media affiliate, the system may track the responses and determine the origin of a respondent's inquiry. For example—a telephone number acting as a manifest indicia on a billboard invites a respondent to make inquiries at that telephone number. If the respondent does make an inquiry using that telephone number, then it is possible to differentiate the source of respondent's inquiry as the billboard and not a radio media campaign, which may use a different telephone number. The system 19 then may receive the respondent response via the manifest indicia as it pertains to the media campaign. (See block 304.) In an exemplary embodiment, the response data may be entered and stored by the system 19 in association with a media campaign by relating the manifest indicia the respondent used with a unique media campaign identifier generated by the system. In one possible embodiment, the response data may be recorded or logged by the system backend 11. In another possible embodiment, the degree of interest for a response may be measured by means of a validity measure 24 as metered or measured by the meter 18 within the system backend 11.In alternate embodiments, any suitable information pertaining to a response data may be recorded by the system backend 11 in any suitable means. (See Block 305.) At block 306, the system backend 11 may store the response data and validity measures as determined by the system backend at block 305 and stores them in the backend. Further, the system backend 11 may be configured to generate invoicing data related to the media campaign to which the response data was made. At block 306, the information related to the media campaign may be displayed to the campaign manager and the contracting media affiliate or any other parties (for example, the administrator/superuser) via the client 12. This information may, in one embodiment, include specific data pertaining to the response data. Additionally this information may also be manipulated by the viewing party. For example, the data may be filtered by any suitable criteria, such as, but not limited to, the number of responses, quality of responses, the time of the response or any other suitable filtering information. The system 19 may also generate statistical information based on data records. In an alternate embodiment, the system 19 may also provide data on billing by using the metering of validity measure based on agreed to rates of billing.

It will be apparent to those skilled in the art that other modifications to and variations of the above-described techniques are possible without departing from the inventive concepts disclosed herein. Accordingly, the invention should be viewed as limited solely by the scope and spirit of the appended claims.

What is claimed is:

1. A system for the metering of the effectiveness of media campaigns, the system comprising:
a network;
a system backend communicable with said network, the system backend having a processor configured to track at least one media campaign, wherein the at least one media campaign is further associated with at least one manifest indicia embodying a media campaign point of contact;
said system backend further configured to communicate via said network with at least one campaign management client managing the at least one media campaign, and define an interface for the at least one campaign management client to associate at least one media affiliate client to the at least one media campaign;
said system backend further configured to communicate via said network with the at least one media affiliate client;
wherein said system backend processor is further configured to receive at least one response associated with said at least one media campaign via said media campaign point of contact; and
wherein said system backend processor is further configured to determine at least one quality measure, of said at least one response from said at least one media campaign, related to a measure of engagement between said at least one campaign management client and said at least one media affiliate client.

2. The system as claimed in claim 1, wherein said quality measure may be determined by the system backend by a predetermined criteria.

3. The system as claimed in claim 1, wherein said quality measure may be manually inputted.

4. The system as claimed in claim 1, wherein said system backend may be further configured to generate statistics using said data associated with the at least one media campaign.

5. The system as claimed in claim 4, wherein said system backend may be further configured to allow said at least one campaign management client to view said statistics.

6. The system as claimed in claim 4, wherein said system backend may be further configured to allow at least one affiliate client to view said statistics.

7. The system as claimed in claim 5, wherein said statistics is filterable by said at least one campaign management client.

8. The system as claimed in claim 6, wherein said statistics is filterable by said at least one affiliate client.

9. The system as claimed in claim 5, wherein said statistics is sortable by said at least one campaign management client.

10. The system as claimed in claim 6, wherein said statistics is sortable by said at least one affiliate client.

11. The system as claimed in claim 2, wherein said predetermined criteria may be selectable by said at least one campaign management client.

12. The system as claimed in claim 2, wherein said predetermined criteria may be selectable by said at least one affiliate client.

13. The system as claimed in claim 1, wherein said at least one media campaign is an offline media campaign.

14. The system as claimed in claim 1, wherein said at least one media campaign is an online media campaign.

15. The system as claimed in claim 1, wherein said at least one campaign management client is further configured to present data associated with the at least one media campaign.

16. The system as claimed in claim 1, wherein said media affiliate client is further configured to present data associated with at least one media campaign associated with said at least one affiliate client.

17. A method for metering the effectiveness of media campaigns, the method comprising:
associating at least one media campaign with at least one manifest indicia embodying a media campaign point of contact;
associating said at least one media campaign to at least one media affiliate, said at least one media affiliate effecting presentation of said at least one media campaign and associated at least one manifest indicia to a given audience;
receiving at least one response associated with said at least one media campaign via said media campaign point of contact;
determining a quality measure associated with said at least one response; and
relating said quality measure to a measure of engagement between said at least one campaign management client and said at least one media affiliate client.

18. The method as claimed in claim 17, wherein said quality measure is determined by a predetermined criteria.

19. The method as claimed in claim 17, wherein said quality measure is manually inputted.

20. The method as claimed in claim 17, wherein said information associated with said at least one media campaign includes statistics information generated from said information associated with at least one media campaign.

21. The method as claimed in claim 17, wherein said information associated with the at least one media campaign is filterable.

22. The method as claimed in claim 17, wherein said information associated with the at least one media campaign is sortable.

23. The method as claimed in claim 18, wherein said predetermined criteria may be selectable by said client.

24. The method as claimed in claim 17, wherein said at least one media campaign is an offline media campaign.

25. The method as claimed in claim 17, wherein said at least one media campaign is an online media campaign.

26. The method as claimed in claim 17, further comprising storing said quality measure with said at least one media campaign.

27. The method as claimed in claim 17, further comprising presenting all information associated with said at least one media campaign to a client.

28. A response validation metering system, the system comprising:
a system backend having a processor configured to receive at least one response data associated with at least one media campaign via at least one manifest indicia embodying a media campaign point of contact;
wherein said processor is further configured to quantify a validity measure based on said at least one response data according to a predetermined criteria;
wherein said processor is further configured to generate invoice data in accordance to said validity measure with respect to said at least one media campaign.
